(19) United States
(12) Patent Application Publication
(10) Pub. No.: US 2002/0030584 A1
(43) Pub. Date: Mar. 14, 2002

(54) Biometric access control system with time and attendance data logging and reporting capabilities

(76) Inventors: Dore Perler, Cooper City, FL (US); Shawn Tartaglia, Lake Worth, FL (US)

Correspondence Address: GOLD & RIZVI, P.A., Suite 450, 600 North Pine Island Rd., Plantation, FL, 33324, US

(21) Appl. No.: 09/951,804

(22) Filed: Sep. 13, 2001

Related U.S. Application Data
(60) Provisional application No. 60/232,473, filed on Sep. 13, 2000.

(51) Int. Cl. H04Q 1/00; H04B 3/00; G06T 1/00; H04B 1/00; G06F 7/00; G06T 7/00; G06F 7/04; G06K 9/00; H04Q 9/00; G08C 19/00; G06K 9/36; G06K 9/20; G08B 29/00; G05B 23/00; G05B 19/00

(52) U.S. Cl. 340/5.53

(57) ABSTRACT

A biometric access control system with time and attendance data logging and reporting capabilities for use in employee access control, time tracking, and processing of payroll data.

The biometric access control system includes a biometric input device configured to capture biometric data, a processor for identifying users based upon the biometric data and for logging time and attendance records for users. A display device is also provided and configured for visual communication.

### CROSS REFERENCE TO RELATED APPLICATION

This application claims the benefit of co-pending U.S. Provisional Patent Application Ser. No. 60/232,473 filed Sep. 13, 2000, which is incorporated by reference herein in its entirety.

### BACKGROUND OF THE INVENTION

1. Field of the Invention

The present invention relates generally to access control systems, and more particularly, to a biometric identification technology comprising a biometric access control system having time and attendance architecture including data logging and reporting capabilities for use in employee access control, time tracking, and processing of payroll data.

2. Description of the Prior Art

To many business owners, payroll represents the single largest expense of doing business. In fact, low employee production, inefficiency, fraud, and theft, are often cited as the leading causes of business failures. In today's competitive business environment, keeping accurate track of employee time and attendance and reducing fraud relating to employee payroll records has become an absolute necessity. Unfortunately, maintaining such records and tracking employee time accurately is very time-consuming, costly, unpleasant, and often unmanageable task. Complications such as the monitoring of employee benefits, legal restrictions on teenage workers, labor law and employment regulations, overtime guidelines, and payroll-related tax implications, for example, have further added to the burden of maintaining accurate time and attendance records.

In the past, smaller organizations and organizations having a stable core of employees with low turnover were able to manually maintain accurate time and attendance data tracking for payroll and other purposes. The smaller size and greater employment condition stablility of the past, enabled identification of employees simply by sight and sound. Today, however, a high degree of employee mobility, along with the increased frequency of large-scale terminations during economic downturns, mergers, acquisitions, and the like, has lead to record levels of employee turnover at private and public companies, as well as governmental organizations. Additionally, for larger organizations, it is simply impossible to track employee time and attendance records manually and extremely difficult, at best, to recognize and positively identify employees by relying solely upon sight and sound. Accordingly, the use of automated identifications systems to automate personal recognition is on the rise.

In an effort to automate the tracking of employee time and attendance records, organizations have resorted to a wide variety of time-clock and punch-card oriented systems in conjunction with passwords, security cards, keys, and other forms of identification for their employees. These attempts, however, have been largely ineffective reducing employee fraud, primarily due to the inability to accurately correlate the person using a security card, password, key, or other device, with the person actually authorized to use the device. Additionally, the issuance and upkeep of security cards, keys, passwords, and other forms of identification is a very time-consuming and costly endeavor for an organization. Furthermore, employees often forget passwords and/or misplace security badges, keys and other forms of identification, requiring the issuance of replacements. The resulting additional administrative costs can be quite substantial. Furthermore, significant losses often result when employees fraudulently punch time clocks for tardy or absent associates. This fraudulent practice, commonly referred to as “buddy punching,” is the cause of substantial inaccuracies in payroll data and constitutes a significant monetary loss to organizations.

One form of automated personal recognition systems are biometric systems. Biometrics is the science of using a measurable physical characteristic or personal trait to recognize or verify the claimed identity of a person. Biometric devices automate personal recognition and identification by comparing unique physical human characteristics such as fingerprints, handprints, iris and retina configurations, facial features, voice and handwriting, to name just a few. The biometric systems of the background art, however, have proven overly complex and unreliable and, consequently, have not met with widespread acceptance.

In view of the drawbacks and limitations of the prior art, there exists a recognized need for biometric identification systems for use in employee time and attendance tracking. One of the biggest problems in controlling payroll costs involves tracking the time and attendance of hundreds, and often thousands, of employees. Accurate payroll requires an accurate time-clock system and reliable time-clock punches. Without correct time-clock punches, inaccurate and possibly fraudulent paychecks can be generated, thereby resulting in substantial waste of corporate and governmental resources.

Accordingly, there exists a need for a reliable, user friendly biometric-based, time and attendance system for providing error-free personal identification, while simultaneously creating a secure audit trail of events to eliminate the potential for employee fraud, time-theft, or unauthorized access.

### SUMMARY OF THE INVENTION

The present invention provides a biometric access control system with time and attendance data logging and reporting capabilities, and an associated method for providing error-free personal identification, access control, and a time and attendance record-keeping system eliminating the potential for employee fraud, time-theft, and unauthorized access. The system includes cooperating hardware and software designed to work as a stand-alone unit. In another aspect of the invention, the system can be configured to operate within a computer networked environment.

A brief summary of the structural and functional characteristics of the present invention follows. Initially, employees record and register one or more personal identifying features using a biometric input device, such as a fingerprint recognition, handprint recognition, iris scanning, retina scanning, facial recognition, thermal recognition, signature metrics, or voice analysis device, to name just a few. The biometric device preferably has the capability to sense, record and store in computer memory a biometric sample associated with a given employee, which biometric sample is then used to compile biometric data for each employee. The biometric access control system is further adapted to receive auxiliary personal employee data, such as name, address, pay rate, hours authorized to work, and the like. This information can be used for, among other things, generating various documents and reports. Thereafter, access, time and attendance data, is preferably recorded each time an employee submits to biometric verification upon entering a facility and, preferably, prior to receiving time and attendance credit.

Accordingly, the biometric access control system of the present invention provides an automated system capable of: (1) capturing a biometric sample from an end user, such as an employee; (2) extracting biometric data from the sample; (3) comparing the biometric data with data contained in one or more reference templates; (4) determining the extent to which any given sample matches one or more reference templates; and 5) indicating whether or not an identification or verification of identity has been achieved.

Using the biometric sample data obtained, a system administrator is able to enter details relating to each user, including, for example, scheduling parameters, wages, overtime wages, authorization information, lockout periods, and the like. The system further allows for the transmission of data, updating of programs, testing of communications, and power-up and shutdown. A system administrator is further capable of oversight functions such as processing, editing, ad adding time and attendance data, for example. The system further provides for the direct transmission of data from the system to an in-house payroll processing program and to any of over 200 different packages.

Accordingly, it is an object of the present invention to provide an improved biometric access control system with time and attendance data logging and reporting capabilities.

Another object of the present invention is to provide a biometric access control system with time and attendance data logging and reporting capabilities for automating personal recognition and identification by comparing unique physical human characteristics.

A further object of the present invention is to provide a biometric access control system with time and attendance data logging capabilities wherein the unique physical human characteristics utilized for identifying an individual may include fingerprints.

An additional object of the present invention is to provide a biometric access control system with time and attendance data logging capabilities wherein the unique physical human characteristics utilized in identifying an individual may include fingerprints taken below the surface layer of the skin so as to obtain an image undistorted by skin surface conditions such as calluses, dryness, dirt, moisture, or the effects of aging.

It is also an object of the present invention to provide a biometric access control system with time and attendance data logging and reporting capabilities that efficiently and accurately obtains and maintains accurate employee time and attendance records.

An additional object of the present invention is to provide a biometric access control system with time and attendance data logging and reporting capabilities that substantially reduces the burden of maintaining accurate time and attendance records.

Another object of the present invention is to provide a biometric access control system with time and attendance data logging and reporting capabilities that prevents the fraudulent practice of one employee improperly entering in time and attendance records for another.

It is also an object of the present invention to provide a biometric access control system with time and attendance data logging and reporting capabilities that can be utilized, if desired, as a stand-alone unit.

An additional object of the present invention is to provide a biometric access control system with time and attendance data logging and reporting capabilities that can be utilized, if desired, with a computer or in a computer network environment.

A further object of the present invention is to provide a biometric access control system with time and attendance data logging and reporting capabilities adapted for communication with any existing computer network environment.

Still another object of the present invention is to provide a biometric access control system with time and attendance data logging and reporting capabilities that can be utilized, if desired, specifically for transmitting data through a TCP/IP protocol.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a perspective front view of a preferred embodiment of the present invention;

FIG. 2 is a perspective rear view of a preferred embodiment of the present invention shown with the rear wall removed; and

FIG. 3 is an illustrative flowchart showing one particular method of practicing the present invention.

Like reference numerals refer to like parts throughout the several views of the drawings.

### DETAILED DESCRIPTION OF THE PREFERRED EMBODIMENTS

Shown throughout the figures, the present invention is directed towards a biometric access control system with time and attendance data logging and reporting capabilities and method which provides a proof positive, personal identification access control and time and attendance data maintaining capabilities and eliminates the potential for employee fraud, time-theft, or unauthorized access. The system includes cooperating hardware and software designed to work as a stand-alone unit and, if desired, also operate and communicate in a computer network environment.

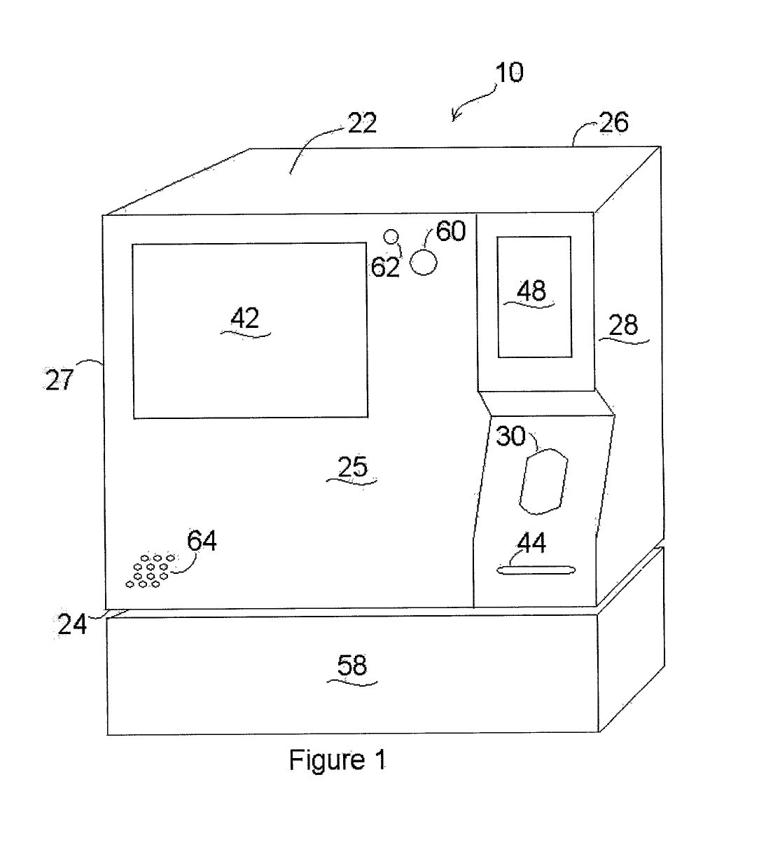

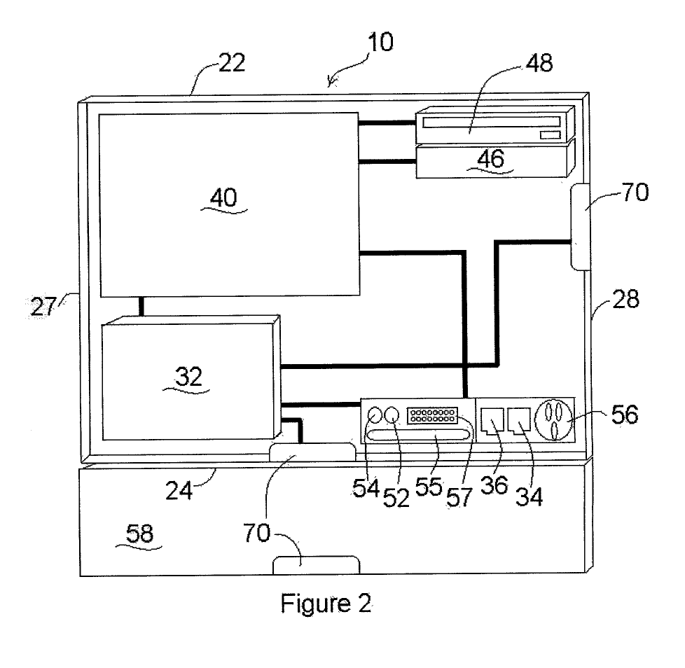

Referring now primarily to FIGS. 1-2, the biometric access control system with time and attendance data logging and reporting capabilities, shown generally as reference numeral 10, is illustrated in accordance with a preferred embodiment of the invention.

As shown, the biometric access control system 10 of the present invention includes a generally hollow main housing 20 configured to substantially surround and protect sensitive components of the biometric access control system 10 from weather, tampering, and other damage. It will be appreciated by those skilled in the art that the main housing 20 may be formed in a wide variety of shapes, sizes, and configurations without departing from the present invention. The main housing 20 will preferably be formed out of an industrial grade metallic material such as Aluminum or steel using any of a number of well-known manufacturing processes. If desired, the main housing 20 can be constructed to be weather and tamper resistant to provide for greater durability and extend the useful life of the biometric access control system 10 of the present invention. In the preferred embodiment, the main housing 20 of the biometric access control system 10 has an interior space defined by a top panel 22, bottom panel 24, front wall 25, rear wall 26, and two substantially opposing side walls 27, 28 as shown. The walls 25, 26, 27, 28 of the main housing 20 will preferably be configured with a number of openings disposed therein to provide access to important components or permit ingress and egress for cables, communication lines, power cords, and the like.

The biometric access control system 10 will include a biometric input device 30 configured to receive unique physical human characteristics to positively identify an individual user, such as an employee. Any of a wide variety of biometric devices may be utilized without departing from the present invention including fingerprint recognition, handprint recognition, iris scanning, retina scanning, facial recognition, thermal recognition, signature metrics, and voice analysis, for example. It will be appreciated by those skilled in the art that any other biometric input devices 30 may also be utilized without departing from the present invention. In a most preferred embodiment, the biometric input device 30 will be a fingerprint sensor. As shown, the biometric input device 30 will be accessible through an opening in the front wall 25 of the main housing 20. It will be appreciated, of course, that any of a number of other known mounting configurations can be utilized to securely position a biometric input device 30, such as a fingerprint sensor, within the main housing 20 of the biometric access control system 10 without departing from the present invention.

The biometric input device 30 of the present invention will preferably have the capability of sensing and storing biometric data in any one of a variety of known storage devices 46, as shown in FIG. 2, using a known computer readable medium such as an internal hard drive, for example. Additionally, as shown in FIG. 2, a floppy disk drive 48 may also be provided. If the biometric input device 30 is a fingerprint sensor, for example, it will preferably have the capability of sensing and storing a biometric fingerprint pattern (i.e. biometric sample) associated with a given employee, which biometric sample is used to compile biometric data for each employee. Any of a number of fingerprint sensors 30 may be utilized in the biometric access control system without departing from the present invention. Fingerprint sensors are commercially available from a wide variety of manufacturers including, for example: Authentic, Inc. of Melbourne, Florida; SAC Technologies, Inc. of Edina, Minnesota; Veridicom of Santa Clara, Calif.; Crossmatch Technologies, Inc. of West Palm Beach, Florida; and SecuGen Corporation of San Jose, Calif. In the preferred embodiment, the biometric access control system 10 will utilize a fingerprint sensor manufactured by Authentic, Inc. of Melbourne, Fla., and sold under the trademark FINGERLOC. An advantage of the FINGERLOC fingerprint sensor is that it incorporates an active antenna array that looks below the surface of the skin to produce an image unaffected and undistorted by skin surface conditions such as calluses, dryness, dirt, moisture, or the effects of aging. It will be appreciated, however, that the embodiment described is exemplary in nature, and any of a wide selection of other fingerprint sensors and other biometric input devices 30 may be readily utilized without departing from the present invention.

The biometric access control system 10 includes a display device 42 preferably viewable through an opening in the front wall 25 of the main housing 20 as shown. The display device 42 may include any of a variety of known devices such as a standard computer monitor. As best shown in FIG. 1, the biometric access control system 10 may be provided with a camera 60 and a camera light 62 along with other known components necessary to take either still photographs or active video of an employee. An audio speaker 64 may also be provided, if desired, to provide audio feedback to users, an alarm for improper usage, or other purposes.

FIG. 2 is a perspective rear view of a preferred embodiment of the present invention shown with the rear wall 26 removed. Referring now primarily to FIG. 2, it is seen that the biometric access control system 10 of the present invention will include a power supply 32 as best shown in FIG. 2. It will be appreciated that any of a number of known configurations may be utilized for the power supply 32 without departing from the present invention. Preferably, a 230-Watt power supply will be provided requiring a 120 VAC input voltage. Of course, other configurations may also be utilized without departing from the invention. As shown in FIG. 2, a standard power input 56, is also provided for the convenient insertion of a power cord therein. In addition to the main power supply 32, the biometric access control system 10 may include an uninterruptible power supply 58 as shown in FIGS. 1-2. Should the biometric access control system 10 experience a power surge or brown out, or if power is disabled, the uninterruptible power supply 58 will preferably be configured to provide battery backup sufficient to save data and shut down safely. It will be appreciated by those skilled in the art that a number of cooling fans 70 can be disposed in the main housing 20 of the biometric access control system 10 to assist in cooling the main housing 20 and help prevent damage to sensitive parts of the biometric access control system 10 due to overheating. Likewise, a cooling fan 70 can also be provided to vent the uninterruptible power supply 58 as shown.

Referring again to FIG. 2, a central processing unit 40 is preferably provided with the biometric access control system 10 as shown. By providing a central processing unit 40, the biometric access control system 10 will have the capability of operating as a stand-alone unit and will also configurable, if desired, to operate in a computer network environment. A wide variety of central processing units 40 may be utilized, including a Pentium-based processor, for example, in the present invention. As central processing units are constantly in a state of improvement, it is contemplated that the specific processing power and configuration utilized may be upgraded, as needed, without departing from the present invention.

A smart card reader/writer 44, as shown in FIG. 1, is preferably provided for the biometric access control system 10 of the present invention. The smart card reader/writer 44 may be utilized as a secondary means of identifying individuals, if desired, by providing employees with a readable smart card. An advantage of the present invention is that a lost or stolen smart card is useless except for the person to whom it was issued. Additionally, as shown in FIG. 1, a standard keypad 48 can be provided so that employees are given the capability to provide alphanumeric input to the biometric access control system 10 of the present invention in addition to having their specific biometric data collected by the biometric data input device 30.

It may be desirable to provide communication components for the biometric access control system 10 to permit input and output of data for a variety of purposes. Preferably, the biometric access control system 10 will include static communication means 34, such as with a permanently active connection. Dynamic communication means 36 may also be provided, such as a remote dial-up modem, for example. Communication may also be desired with any of a variety of other devices such as a keyboard or mouse, for example. As such, it may be desirable to provide a keyboard connector 52 and a mouse connector 54. A parallel input/output port 55 can also be provided as well as an access control connector 57, as shown. The communication ports and components described are exemplary only, and it will be appreciated by those skilled in the art that any of a large number of communication components and configurations can be utilized without departing from the present invention.

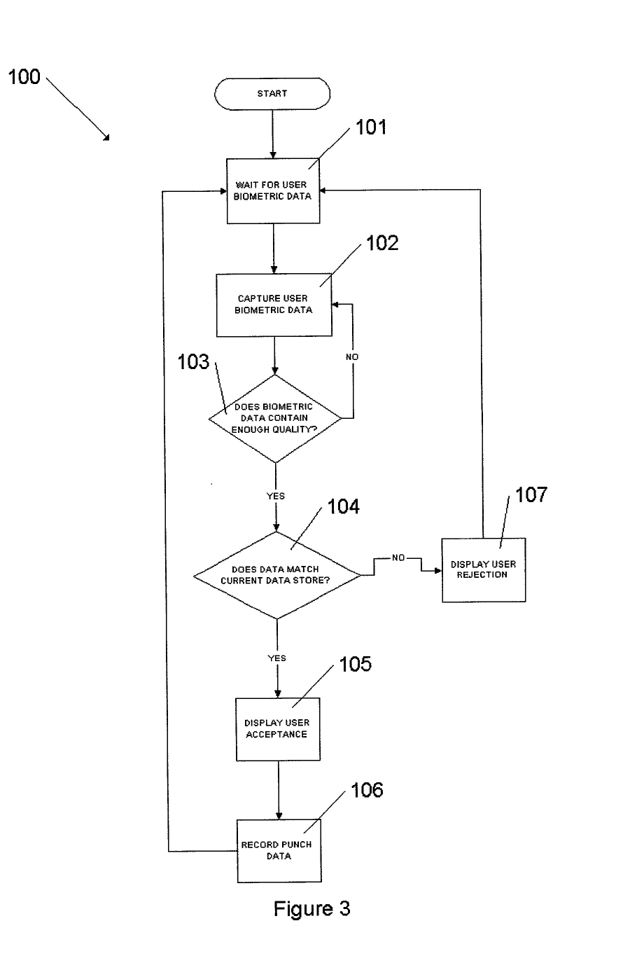

FIG. 3 is an illustrative flowchart showing one method 100 of practicing the present invention. In accordance with the preferred embodiment as set forth in step 101 of FIG. 3, employees must first wait for the biometric input device 30 of the biometric access control system 10 to accept their biometric data. Where, for example, the biometric input device 30 is a fingerprint sensor, as in the preferred embodiment, an employee simply places a finger in registration with the fingerprint sensor. At step 102, the fingerprint sensor captures and stores a biometric sample or fingerprint pattern associated with a given employee. The biometric sample is then reviewed for quality in step 103. Heavy pressure, excessive moisture, lack of natural moisture in the skin, among other variables can cause an insufficient fingerprint pattern to be recorded. As shown in FIG. 3, biometric data may be of insufficient quality and the employee may be asked to repeat step 102 so that the fingerprint sensor or other biometric input device 30 can capture and store a biometric sample. Where the biometric sample is of sufficient quality, the biometric characteristics of the employee is compared against the database of stored biometric samples to determine an individual's identity. If the identity is verified, user acceptance is displayed as shown in step 105 and the punch data is subsequently recorded, as shown in step 106. User acceptance may be displayed on the display device 42, if desired, and an audio acceptance may also be provided via audio speaker 64. On the other hand, where the data does not match any stored biometric characteristics, user rejection is displayed as shown in step 107. Again, user rejection can be displayed on the display device 42, if desired, and an audio rejection may be provided via audio speaker 64. The biometric access control system 10 can be further adapted to accept employee information, such as name, address, pay rate, hours authorized to work, and the like, for use by the system and in various reports. Thereafter, access and time and attendance data can be obtained, as desired, as each employee is required to submit to biometric verification prior to obtaining access to a given facility and preferably, prior to receiving time and attendance credit. It should be noted, that the specific method described of utilizing the present invention is only one example and is provided for illustrative purposes only. A wide variety of other applications and uses adaptable and configured for specific conditions is contemplated.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

We claim:

1. A biometric access control system having time and attendance data logging and reporting capabilities, comprising:
a biometric input device having means for reading and recording human biometric data;
a computer processor in electronic communication with said biometric input device, said processor configured for identifying system users based upon said biometric data and for recording user time and attendance data; and
a display device configured for visual communication.

2. A biometric access control system with time and attendance data logging and reporting capabilities of claim 1, further comprising an audio speaker configured for audio communication.

3. A biometric access control system with time and attendance data logging and reporting capabilities of claim 1, wherein said biometric input device is a fingerprint sensor.

4. A biometric access control system with time and attendance data logging and reporting capabilities of claim 1, further comprising a keypad for entry of alphanumeric characters.

5. A biometric access control system with time and attendance data logging and reporting capabilities of claim 1, further including and being substantially surrounded by a main housing.

6. A biometric access control system with time and attendance data logging and reporting capabilities of claim 5, wherein said main housing comprises a top panel, a bottom panel, a front wall, a rear wall, and a pair of substantially opposing side walls defining an interior space within.

7. A biometric access control system with time and attendance data logging and reporting capabilities of claim 1, wherein said biometric input device is an iris scanner.

8. A biometric access control system with time and attendance data logging and reporting capabilities of claim 1, wherein said biometric input device is a handprint sensor.

9. A biometric access control system with time and attendance data logging and reporting capabilities of claim 1, wherein said biometric input device is a retina scanner.

10. A biometric access control system with time and attendance data logging and reporting capabilities of claim 1, wherein said biometric input device is a facial recognition scanner.

11. A biometric access control system with time and attendance data logging and reporting capabilities of claim 1, wherein said biometric input device is a thermal recognition scanner.

12. A biometric access control system with time and attendance data logging and reporting capabilities of claim 1, wherein said biometric input device is a signature recognition device.

13. A biometric access control system with time and attendance data logging and reporting capabilities of claim 1, wherein said biometric input device is a voice recognition device.
